(19) United States
(12) Patent Application Publication
(10) Pub. No.: US 2006/0140447 A1
(43) Pub. Date: Jun. 29, 2006

(54) Vehicle-monitoring device and method using optical flow

(75) Inventors: Sang-Cheol Park, Seoul (KR); Kwang-Soo Kim, Seoul (KR); Kyong-Ha Park, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/236,236

(22) Filed: Sep. 27, 2005

(30) Foreign Application Priority Data
Dec. 28, 2004 (KR) 114083/2004

(51) Int. Cl. G06K 9/00

(52) U.S. Cl. 382/104; 382/103

(57) ABSTRACT

Provided is a vehicle detection/tracking device that allows vehicle detection and then tracking using a camera focusing around a camera-mounted vehicle. To this end, an optical flow is acquired from video data input through a camera mounted in a vehicle during driving of the vehicle. A background optical flow, an optical flow generated by driving the vehicle, is acquired. The acquired optical flow and the acquired background optical flow are compared, and a vehicle candidate area is detected through an optical flow for an object around the vehicle. In particular, template matching is performed on the vehicle candidate area for vehicle detection and a detected vehicle can be tracked by continuously comparing the detected optical flow and the background optical flow.

### PRIORITY

This application claims priority under 35 U.S.C. § 119 to an application entitled “Vehicle-monitoring Device and Method Using Optical Flow” filed in the Korean Intellectual Property Office on Dec. 28, 2004 and assigned Ser. No. 2004-114083, the contents of which are incorporated herein by reference.

### BACKGROUND OF THE INVENTION

1. Field of the Invention

The present invention generally relates to a vehicle detection/tracking method and device, and in particular, to a vehicle detection/tracking method and device using an optical flow, in which real-time vehicle detection is accomplished by calculating an optical flow using a vehicle-mounted camera.

2. Description of the Related Art

Conventionally, a vehicle motion is detected using a shadow cast by the vehicle or by horizontal edges of the vehicle in a photographed image.

Shadow detection involves designating a vehicle candidate area using a shadow where the vehicle meets a road and detecting the vehicle by checking symmetry of the designated vehicle candidate area. Detection by photograph involves acquiring horizontal edges from a photographed image of the vehicle, designating an area where a predetermined portion of the horizontal edges appears as a vehicle candidate area, and detecting the vehicle using the designated vehicle candidate area and vehicle templates.

However, shadow detection is unreliable at night or in the rain, because the vehicle candidate area is reduced due to the dark and wet conditions. Moreover, since the shadow cast in the morning or evening is long because of the position of the sun, performance is degraded by time zones. In addition, the shadows of two parallel vehicles may overlap on the road surface. As a result, shadow detection may detect two vehicles as one vehicle. Thus, shadow detection has difficulty handling a new vehicle that is not subject to tracking.

The horizontal-edge-photograph detection uses information about the color or area of the road, and is not subject to the problems of shadow detection, but detection performance degrades on a curved or uphill/downhill road.

As described above, conventional vehicle detection performance is degraded by changes in a shadow, the parallel running of vehicles, and weather conditions.

### SUMMARY OF THE INVENTION

It is, therefore, an object of the present invention to provide a vehicle detection/tracking method and device using an optical flow, in which a target vehicle is detected in real time by calculating an optical flow using a camera mounted in a source vehicle and tracking the detected target vehicle.

To achieve the above and other objects, there is provided a vehicle-monitoring device using an optical flow. The vehicle-monitoring device includes a video pre-processor, an optical flow detector, and a vehicle detector. The video pre-processor processes video data input through a camera. The optical flow detector detects an optical flow from the input video data and separates a background optical flow area from the detected optical flow. The vehicle detector matches the remaining area of the detected optical flow except for the background optical flow area to templates to determine whether the remaining area is an area of a target vehicle.

To achieve the above and other objects, there is also provided a vehicle-monitoring method using an optical flow. The vehicle-monitoring method includes pre-processing video data input through a camera, detecting an optical flow from the input video data and separating a background optical flow from the detected optical flow, matching the remaining area of the detected optical flow except for the background optical flow to templates, and detecting information on a target vehicle if the remaining area is an area having motions of the target vehicle and detecting the target vehicle.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a vehicle-monitoring device having vehicle detection/tracking functions according to an embodiment of the present invention;

FIG. 2 illustrates an input image and an optical flow of the input image according to an embodiment of the present invention;

FIG. 3 illustrates a change in an optical flow according to a change in speed of a source vehicle according to an embodiment of the present invention;

FIG. 4 illustrates a change in an optical flow according to a change in a steering wheel angle of a source vehicle according to an embodiment of the present invention;

FIG. 5 is a view for explaining a process of extracting an optical flow for a target vehicle according to an embodiment of the present invention;

FIG. 6 illustrates templates for various vehicle types according to an embodiment of the present invention;

FIG. 7A is a view for calculating motion information according to a vector direction according to an embodiment of the present invention;

FIG. 7B is a view for calculating a relative speed according to a vector size according to an embodiment of the present invention;

FIG. 8 is a control flowchart for vehicle detection according to an embodiment of the present invention; and

FIG. 9 is a control flowchart for vehicle tracking according to an embodiment of the present invention.

### DETAILED DESCRIPTION OF THE PREFERRED EMBODIMENT

Preferred embodiments of the present invention will now be described in detail with reference to the annexed drawings. In the following description, a detailed description of known functions and configurations incorporated herein has been omitted for conciseness.

The present invention provides a vehicle detection/tracking device that allows vehicle detection and then tracking using a camera focusing around a source vehicle having the camera mounted therein. To this end, in the present invention, an optical flow is acquired from video data that is input through a camera mounted in the source vehicle while driving the source vehicle. Then, a background optical flow generated from driving is acquired, the optical flow and the background optical flow are compared, and a vehicle candidate area is detected using an optical flow of motions of objects around the source vehicle which is acquired as the result of the comparison. In particular, in the present invention, a target vehicle is detected by matching a vehicle candidate area to vehicle templates and is then tracked by continuously comparing an optical flow and a background optical flow for the detected target vehicle.

The optical flow represents apparent motions between two temporally different video data that are photographed and input from a camera as vectors. A vehicle detection method using optical flow involves comparing pixels of a previously photographed frame and pixels of a currently photographed frame. Alternatively, the method may involve dividing a previous image into a plurality of unit blocks, each having a predetermined number of pixels, dividing a current image into a plurality of unit blocks, each having the same size as a unit block of the previous image, and comparing the unit blocks of the previous image with the unit blocks of the current image while moving the current image pixel-by-pixel to calculate differences between luminance or chrominance values of the previous image pixels and the current image pixels, and expressing previous image pixel motion using vectors based on the calculated differences, and if a vector having a size that is more than a specific value is generated in a specific area, detecting a target vehicle using the vector.

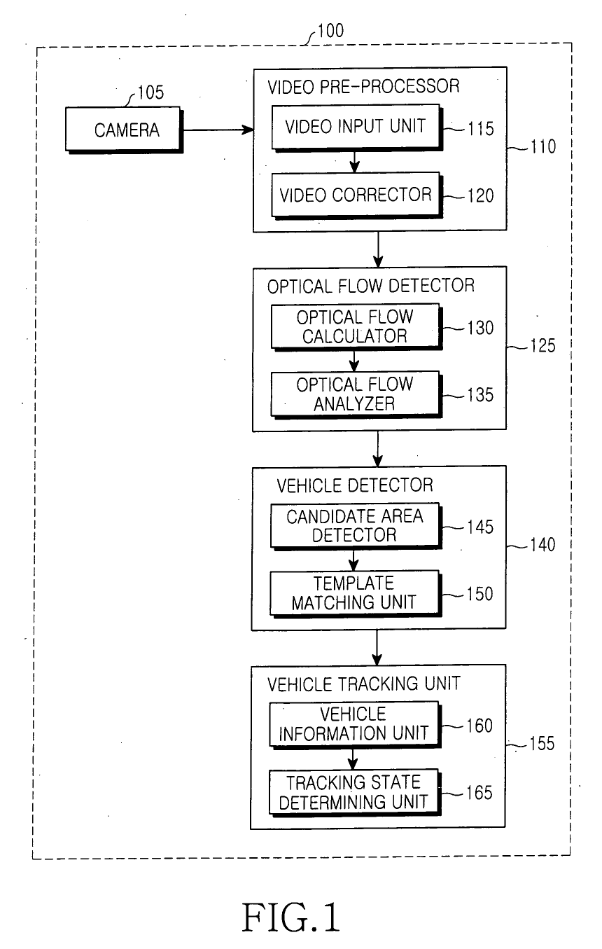

Hereinafter, functions of components of a vehicle detection/tracking device according to an embodiment of the present invention will be described, and a device having vehicle detection/tracking functions according to an embodiment of the present invention will be referred to as a vehicle-monitoring device. FIG. 1 is a block diagram of a vehicle-monitoring device according to an embodiment of the present invention.

Referring to FIG. 1, the vehicle-monitoring device 100 detects a moving target vehicle by analyzing an optical flow of video data input through a camera 105 mounted in a source vehicle and tracks the detected target vehicle.

The vehicle-monitoring device 100 includes a video pre-processor 110 that pre-processes an image input through the camera 105, an optical flow detector 125 that detects an optical flow for detection of a motion of a target vehicle from the input image, a vehicle detector 140 that detects a vehicle candidate area for vehicle detection using the detected optical flow, and a vehicle tracking unit 155 that tracks the detected target vehicle using information about the detected target vehicle.

The camera 105 photographs a monitoring area and outputs video data that takes the form of an analog signal. In other words, the camera 105 outputs video data to the video pre-processor 110. A video input unit 115 of the video pre-processor 110 digitizes the input video data to acquire information about a moving target vehicle from the entire video data. A video corrector 120 filters the digital video data to remove noise. The video corrector 120 includes a filter for removing noise, e.g., a noise removing filter from the input video data, such as a Gaussian filter or a median filter. Thus, the video corrector 120 corrects the input video data through filtering.

The optical flow detector 125 detects target vehicle motion and optical flow to separate an area having motions and a background from the video data. In other words, the optical flow detector 125 detects an optical flow to separate a moving target vehicle and a stationary background from the entire video data,. Specifically, an optical flow calculator 130 of the optical flow detector 125 calculates an optical flow of the whole video data to separate a moving target vehicle and a background that is stationary with respect to the fixed camera 105. There are various methods for calculating an optical flow. In the present invention, a Lukas & Kanade method as described in Equation (1) below will be used:

$$[ \begin{matrix}{I}_{x} & {I}_{y}\end{matrix} ] [ \begin{matrix}u \\ v\end{matrix} ] = - {I}_{l} \qquad ( 1 )$$

where Iₓ represents partial differentiation with respect to pixels in x coordinates, I_{y} represents partial differentiation with respect to the pixels in y coordinates, and u and v represent an input image coordinate system. Using Equation (1), partial differentiation Iₜ on the pixels with respect to time t is acquired.

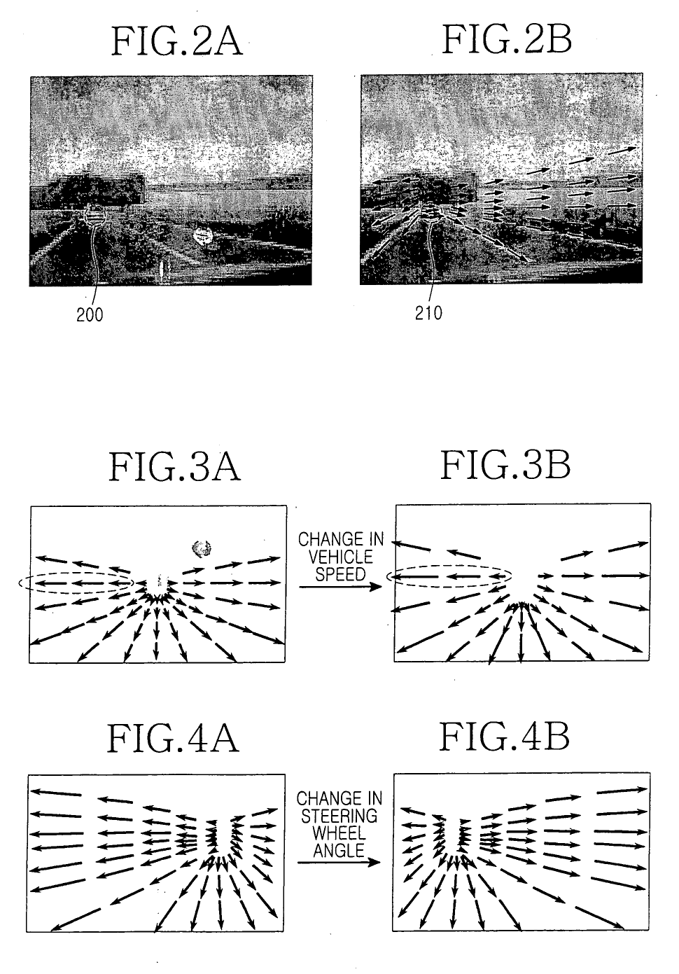

For example, upon input of an image as shown in FIG. 2A, the optical flow detector 125 detects an optical flow as shown in FIG. 2B through a process that uses Equation (1). In the image shown in FIG. 2A, a target vehicle 200 is moving. Optical flow for the moving target vehicle 200 is detected in the form of vectors 210 as shown in FIG. 2B.

As shown in FIG. 2B, the optical flow is expressed as vectors. The area of the target vehicle 200, with smaller vectors and the background, is shown with larger vectors along the direction of motion of the target vehicle 200. The sizes of the vectors of the optical flow change according to the speed of the moving target vehicle 200, but the pattern of the vectors 210 is constant.

While driving a source vehicle, a pattern of an optical flow for a moving target vehicle and a pattern of an optical flow for a stationary background are generated as shown in FIG. 2B. In particular, while a source vehicle is driven, a pattern of an optical flow for a background is maintained constant so that another pattern of an optical flow for another area, except for an area displaying the pattern, is displayed. Thus, an optical flow for the other area takes another pattern that is different from that of the background. An optical flow analyzer 135 stores information about the area for which the optical flow takes another pattern, i.e., information about a vehicle candidate area, in units of a square area, i.e., in units of a pixel. In this way, by separating an optical flow for a moving target vehicle from an optical flow for a background, all area other than the optical flow for the background is designated as a vehicle candidate area.

The optical flow analyzer 135 detects the area except for the background from the optical flow, which is calculated by the optical flow calculator 130 using Equation (1). To separate the optical flow for the background according to an embodiment of the present invention, the optical flow analyzer 135 refers to an optical flow lookup table. The optical flow lookup table tabulates optical flows mapped to steering wheel angles and speeds of a source vehicle, stored in the form of a database.

For example, FIG. 3 illustrates a change in an optical flow according to a change in a speed of a source vehicle according to an embodiment of the present invention, and FIG. 4 illustrates a change in an optical flow according to a change in a steering wheel angle of the source vehicle according to the present invention. Referring to FIG. 3, in an optical flow directed outward from its center, vectors inside a dotted circle in FIG. 3A are expressed larger than those in FIG. 3B as the speed of the source vehicle increases. Each optical flow is mapped to a corresponding speed of the source vehicle.

In addition, as shown in FIG. 4, an optical flow is also expressed differently according to a steering wheel angle of the source vehicle. The optical flow lookup table includes not only an optical flow according to either the steering wheel angle of the source vehicle or the speed of the source vehicle, but also an optical flow according to both the steering wheel angle of the source vehicle and the speed of the source vehicle. Such an optical flow according to the steering wheel angle and/or speed of the source vehicle will be referred to as a background optical flow.

Once the vehicle candidate area is designated, the vehicle detector 140 extracts an area by removing the background optical flow to detect the target vehicle in the area. In other words, the vehicle detector 140 performs vehicle detection including determination of an actual type of the moving target vehicle once the vehicle candidate area is designated.

More specifically, a candidate area detector 145 of the vehicle detector 140 separates the moving target vehicle optical flow and the background optical flow the video data and performs an operation for removing the background optical flow. The candidate area detector 145 searches in the optical flow lookup table for the background optical flow corresponding to current speed and steering wheel angle of the source vehicle and extracts the background optical flow by finding the matching optical flows in the lookup table.

In other words, the candidate area detector 145 compares an optical flow of the entire video data with the background optical flow corresponding to current speed and steering wheel angle of the source vehicle using the optical flow lookup table, hereinafter referred to as matching. If there is an area matched to the background optical flow as the result of the comparison, the optical flow for the target vehicle remains after removing the matched area from the optical flow of the entire video data.

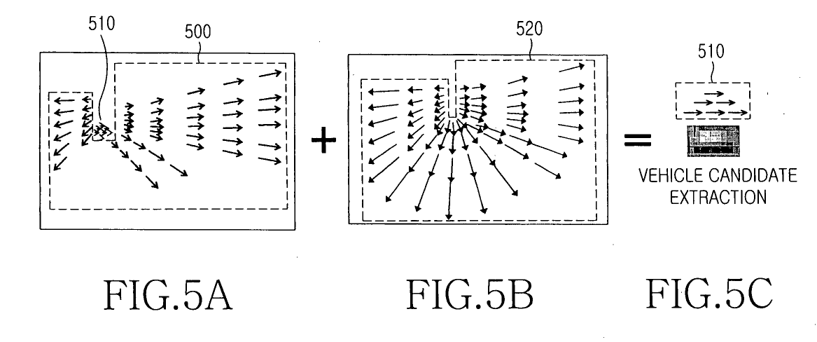

FIG. 5 is a view for explaining a process of extracting an optical flow for a target vehicle according to an embodiment of the present invention. More specifically, FIG. 5A illustrates optical flow of the entire video data of FIG. 2B. The optical flow of FIG. 5A is divided into a background optical flow 500 and an optical flow 510 for the target vehicle.

The candidate area detector 145 searches the optical flow lookup table for an optical flow corresponding to the current speed and steering wheel angle of the source vehicle and detects an optical flow 520 as shown in FIG. 5B. The candidate area detector 145 matches an optical flow of the entire video data to a background optical flow 520 of FIG. 5B to determine whether the entire video data includes an area that matches the background optical flow 520. Thus, if the background optical flow 500 is similar to the background optical flow 520, the candidate area detector 145 removes the background optical flow 500. In this way, the background optical flow is removed from the optical flow of the entire video data and only the optical flow 510 for the target vehicle remains, thereby detecting the vehicle candidate area.

Once only the vehicle candidate area remains, a template-matching unit 150 examines the correlation between the vehicle candidate area and previously created templates for various vehicle types for vehicle candidate detection.

Here, vehicle detection using templates for various vehicle types involves previously preparing an image of each vehicle type, creating templates with an average image of each vehicle type, and detecting a vehicle using the created templates.

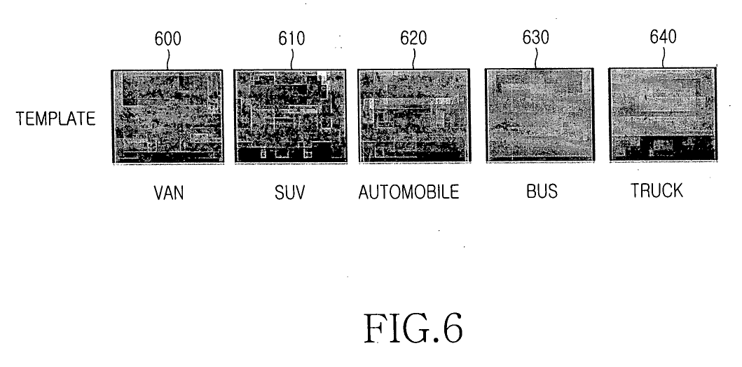

For example, referring to FIG. 6, templates are shown, each of which is an average image of each vehicle type. In FIG. 6, a van template 600 acquired by averaging images of vans is shown. Similarly, an SUV template 610, an automobile template 620, a bus template 630, and a truck template 640 are shown in FIG. 6. In other words, since there are various kinds of buses, the bus template 630 is acquired by averaging images of the buses.

The template-matching unit 150 compares the detected vehicle candidate area with templates as shown in FIG. 6 to determine whether the detected vehicle candidate area corresponds to an actual image of the target vehicle. In the foregoing description, template matching is used to detect the actual target vehicle from the vehicle candidate area. However, Principle Component Analysis (PCA) transformation or Support Vector Machine (SVM) may be used. As such, a result from the template-matching unit 150 indicates not only whether the vehicle candidate area corresponds to an actual image of the target vehicle but also the type of the target vehicle.

Through the foregoing process, a vehicle candidate area is detected from the entire video data, the target vehicle is recognized through template matching in the detected vehicle candidate area, and the type of the target vehicle is determined.

After completion of vehicle detection, vehicle tracking is available. The vehicle-tracking unit 155 performs the vehicle tracking. To track a moving target vehicle, the vehicle-tracking unit 155 predicts a next position of the target vehicle using a prediction algorithm.

More specifically, a vehicle information unit 160 of the vehicle tracking unit 155 predicts the position of the target vehicle in the next frame based on vehicle information output from the template matching unit 150, i.e., information on a current image of the moving target vehicle and information on a previous image of the moving target vehicle. In other words, the vehicle information unit 160 compares information on a vehicle area in the previous image and a vehicle prediction area in the current image through optical flow detection.

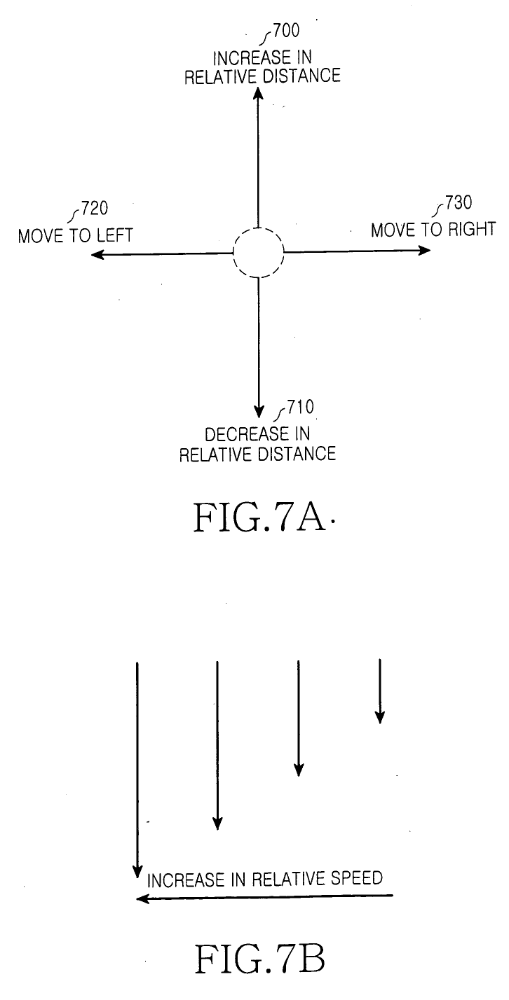

At this time, the vehicle information unit 160 predicts the target vehicle position by calculating relative speed and motion information of the target vehicle. FIG. 7A is a view for calculating motion information according to a vector direction according to an embodiment of the present invention. FIG. 7B is a view for calculating a relative speed according to a vector size according to an embodiment of the present invention.

Referring to FIG. 7A, the vehicle information unit 160 recognizes that a relative distance between the target vehicle and the source vehicle increases if the vector 700 is directed upward. On the other hand, if the vector 710 is directed downward, the vehicle information unit 160 recognizes that a relative distance between the target vehicle and the source vehicle decreases.

Referring to FIG. 7B, the vehicle information unit 160 recognizes that a relative speed between the target vehicle and the source vehicle increases if a vector size increases. On the other hand, if the vector size decreases, the vehicle information unit 160 recognizes that the relative speed decreases. Thus, the vehicle information unit 160 calculates the relative speed and motion information of the target vehicle to predict the target vehicle position.

A tracking state determining unit 165 determines the accuracy of the tracking by comparing information on the actual position of the target vehicle in the next frame with the predicted information on the target vehicle. If there is an error within a predetermined range, vehicle tracking continues. Otherwise, information on the target vehicle is acquired again from the input video data and vehicle tracking is automatically performed again. When a new vehicle area is generated, the tracking state determining unit 165 also acquires information on the new target vehicle and tracks the new target vehicle through detection of the new vehicle area.

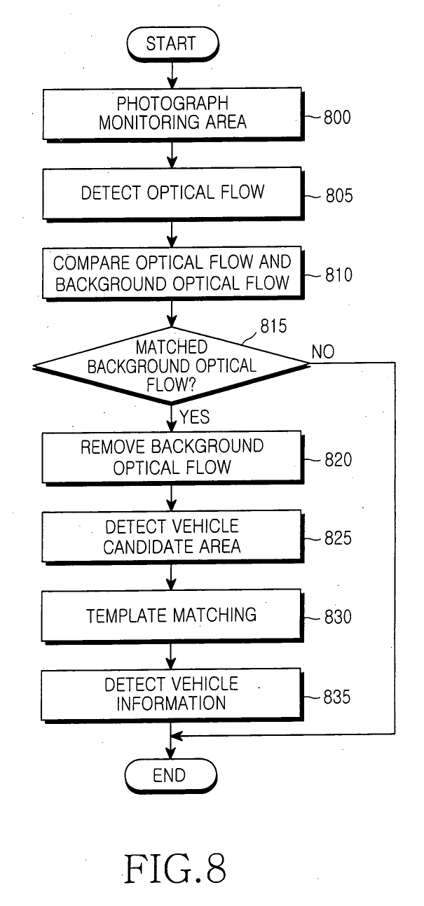

FIG. 8 is a control flowchart for vehicle detection according to an embodiment of the present invention.

First, the vehicle-monitoring device photographs a monitoring area through the camera 105 in step 800. The vehicle-monitoring device then pre-processes input video data acquired through the photographs. The vehicle-monitoring device detects an optical flow from the pre-processed input video data in step 805 and proceeds to step 810 to compare the detected optical flow with a background optical flow in the optical flow lookup table. The vehicle-monitoring device proceeds to step 815 to determine whether there is an area that matches the background optical flow in the optical flow of the entire video data. If there is a match, only the area matched to the background optical flow is removed from the entire image in step 820. Thus, a vehicle candidate area is detected in step 825 and is matched to previously stored vehicle templates in step 830.

After template matching, the vehicle-monitoring device proceeds to step 835 to detect information on whether the detected vehicle candidate area corresponds to an actual image of the target vehicle, or to detect vehicle information, such target vehicle type. In this way, vehicle detection is performed on the entire video data input through the camera 105.

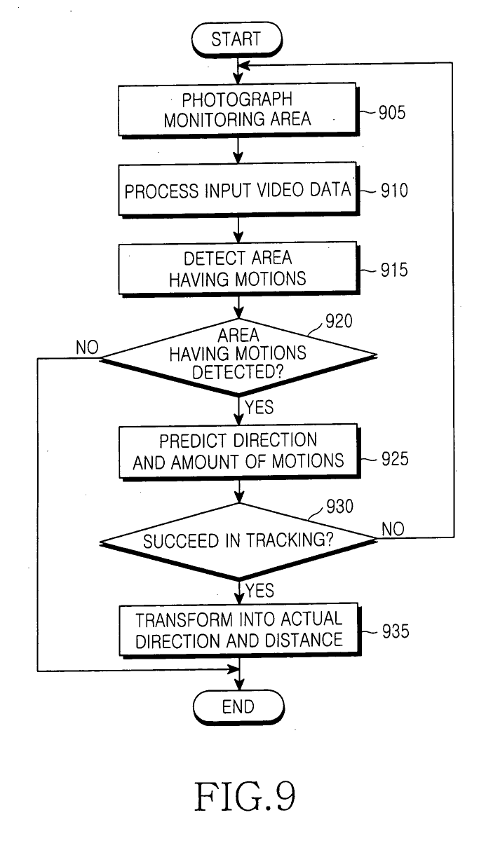

FIG. 9 is a control flowchart for vehicle tracking according to an embodiment of the present invention.

First, once the camera 105 photographs a monitoring area in step 905, the video pre-processor 110 pre-processes input video data acquired from the photographs in step 910. The optical flow detector 125 detects an optical flow from the pre-processed input video data and the vehicle detector 140 detects an area having motion through optical flow detection. It is determined whether there is an area having motion in step 920. If there is an area with motion detected, the process proceeds to step 925. The vehicle-tracking unit 155 predicts the target vehicle direction and the amount of target vehicle motion using information on the detected area in step 925. In other words, the relative speed and motion information of the target vehicle are predicted based on the vehicle candidate area. Once the predicted information is acquired, it is compared with the actual information on the target vehicle to determine a tracking result.

The vehicle-tracking unit 155 determines whether any tracking error is within a predetermined range in step 930 to determine whether tracking is successful. If the error is within the predetermined range, the vehicle-tracking unit 155 recognizes that tracking is successful and continues tracking the moving target vehicle while transforming the direction and amount of motion of the target vehicle into its actual direction and distance. The actual direction and distance may be updated and displayed in real time on a screen of the vehicle detection/tracking device to allow a user to check the actual direction and distance.

As described above, according to the present invention, a surrounding vehicle can be tracked by minimizing an influence from a surrounding environment such as a night, rainy, or snowy environment. In addition, the present invention can be applied to products capable of preventing collision with front or rear vehicles during driving and determining whether surrounding vehicles are within a dangerous distance.

While the invention has been shown and described with reference to a certain preferred embodiment thereof, it will be understood by those skilled in the art that various changes in form and details may be made therein without departing from the spirit and scope of the invention.

What is claimed is:

1. A vehicle-monitoring device using an optical flow, the vehicle-monitoring device comprising:
a video pre-processor for pre-processing video data input through a camera;
an optical flow detector for detecting an optical flow from the video data and separating a background optical flow area from the detected optical flow; and
a vehicle detector for matching a remaining optical flow area; except for the background optical flow area, to templates to determine whether the remaining optical flow area is an area of a target vehicle.

2. The vehicle-monitoring device of claim 1, wherein the vehicle detector performs vehicle detection by determining a type of the target vehicle when the remaining optical flow area is the area of the target vehicle.

3. The vehicle-monitoring device of claim 1, wherein the video pre-processor comprises:
a video input unit for digitizing the video data; and
a video corrector for performing filtering to remove noise from the video data.

4. The vehicle-monitoring device of claim 1, wherein the optical flow detector comprises:
an optical flow calculator for calculating an optical flow of the video data; and
an optical flow analyzer for storing information about an area that shows a pattern different from a stationary area optical flow pattern.

5. The vehicle-monitoring device of claim 4, wherein the optical flow analyzer extracts a background optical flow from the video data by referring to an optical flow lookup table that stores background optical flows mapped to at least one of a vehicle steering wheel angle and speed information.

6. The vehicle-monitoring device of claim 1, wherein the vehicle detector comprises:
a candidate area detector for searching for a background optical flow corresponding to speed and steering wheel angle information of a source vehicle stored in an optical flow lookup table and extracting as a vehicle candidate area the area remaining after removing a background from the video data through matching; and
a template matching unit for examining correlation between the vehicle candidate area and previously stored templates for various vehicles types to determine whether the detected vehicle candidate area corresponds to an actual image of the target vehicle or a type of the target vehicle.

7. The vehicle-monitoring device of claim 1, further comprising a vehicle-tracking unit for tracking the target vehicle using information on the detected target vehicle.

8. The vehicle-monitoring device of claim 7, wherein the vehicle-tracking unit further comprises:
a vehicle storing unit for predicting a position in a next frame to which the target vehicle detected by the vehicle detector is to be moved based on information on a current image of the target vehicle and information on a previous image of the target vehicle; and
a tracking state determining unit for determining a result of tracking by comparing information on the target vehicle actually acquired from the next frame with predicted information on the target vehicle.

9. The vehicle-monitoring device of claim 8, wherein the vehicle detector continues tracking the target vehicle if an error of tracking is within a predetermined range or repeats automatic tracking if the error of tracking is outside the predetermined range.

10. A vehicle-monitoring method using an optical flow, the vehicle-monitoring method comprising the steps of:
pre-processing video data;
detecting an optical flow from the video data and separating a background optical flow from the detected optical flow;
matching a remaining optical flow area, except for the background optical flow area, to templates; and
detecting information on a target vehicle if the remaining optical flow area is an area having motion of the target vehicle; and,
detecting the target vehicle.

11. The vehicle-monitoring method of claim 10, wherein the step of separating the background optical flow comprises the steps of:
calculating an optical flow of the video data; and
comparing the calculated optical flow with a corresponding background optical flow previously stored in an optical flow lookup table.

12. The vehicle-monitoring method of claim 11, wherein the optical flow lookup table stores background optical flows that vary with speed and steering wheel angle information of a source vehicle having a camera mounted therein.

13. The vehicle-monitoring method of claim 11, wherein the step of comparing the calculated optical flow with the background optical flow comprises:
searching for a corresponding background optical flow among previously stored background optical flows according to speed and steering wheel angle information of a source vehicle; and
extracting the corresponding background optical flow from the input image if a corresponding background optical flow is found.

14. The vehicle-monitoring method of claim 10, wherein the step of matching the remaining optical flow area, except for the background optical flow area, to templates comprises:
extracting the area remaining after removal of a background as a vehicle candidate area;
examining correlation between the vehicle candidate area and previously stored templates of various types of vehicles; and
determining whether the detected vehicle candidate area is an actual image of the target vehicle or a type of the target vehicle.

15. The vehicle-monitoring method of claim 10, further comprising the step of tracking the target vehicle using information on the target vehicle.

16. The vehicle-monitoring method of claim 15, wherein the step of tracking the target vehicle comprises:
predicting a position in a next frame to which the target vehicle is to be moved based on a current image of the target vehicle and information on a previous image of the target vehicle; and
determining a result of tracking by comparing information on the target vehicle in the next frame with predicted information on the target vehicle.

17. The vehicle-monitoring method of claim 16, wherein the step of predicting the position in the next frame comprises the step of calculating relative speed and motion information of the target vehicle.

18. The vehicle-monitoring method of claim 10, wherein the video data is input by a camera.
